(19) United States
(12) Patent Application Publication
(10) Pub. No.: US 2014/0129965 A1
(43) Pub. Date: May 8, 2014

(54) GUIDED ACTIVITY WITH USER'S DEFINED STEPS

(71) Applicants: Alex Sorin, Scotts Valley, CA (US); Yung-Yin Chen, Cupertino, CA (US); Wu Cao, Redwood City, CA (US)

(72) Inventors: Alex Sorin, Scotts Valley, CA (US); Yung-Yin Chen, Cupertino, CA (US); Wu Cao, Redwood City, CA (US)

(73) Assignee: SAP AG, Walldorf (DE)

(21) Appl. No.: 13/719,083

(22) Filed: Dec. 18, 2012

Related U.S. Application Data
(60) Provisional application No. 61/724,164, filed on Nov. 8, 2012.

(51) Int. Cl. G06F 3/0481

(52) U.S. Cl. CPC G06F 3/0481
USPC 715/762

(57) ABSTRACT

A dynamic wizard having guided activity with user-defined steps is disclosed. A predefined guided procedure framework is presented to an end user. The predefined guided procedure framework comprises at least one step. The predefined guided procedure framework is modified in response to prompting from the end user. In some embodiments, modifying the predefined guided procedure framework comprises creating a user-defined step and inserting the user-defined step into the predefined guided procedure framework.

### CROSS-REFERENCE TO RELATED APPLICATIONS

This application claims priority to U.S. Provisional Application No. 61/724,164, filed on Nov. 8, 2012, and entitled, “DYNAMIC WIZARD: GUIDED ACTIVITY WITH USER'S DEFINED STEPS,” which is hereby incorporated by reference in its entirety as if set forth herein.

### TECHNICAL FIELD

The present application relates generally to the technical field of wizards, and, in one specific example, to a dynamic wizard having guided activity with user-defined steps.

### BACKGROUND

End users who need to perform complex actions using unfamiliar processes frequently experience confusion that may lead to incomplete or misunderstood task fulfillment. A wizard is a software-implemented user interface that leads the end user through a series of well-defined steps. Current wizards do not allow end users to modify a process according to their needs.

### BRIEF DESCRIPTION OF THE DRAWINGS

Some embodiments are illustrated by way of example and not limitation in the figures of the accompanying drawings in which:

FIG. 1 is a network diagram illustrating a client-server system, within which an example embodiment can be deployed;

FIG. 2 is a block diagram illustrating example enterprise applications and services in an example enterprise application platform;

FIG. 3 is a flowchart illustrating an example method of a dynamic wizard, in accordance with an example embodiment;

FIG. 4 is a flow diagram illustrating an example embodiment of a dynamic wizard task flow for editing a composite object;

FIG. 5 is a flow diagram illustrating an example embodiment of a dynamic wizard task flow for creating a composite object;

FIG. 6 is a block diagram illustrating an example embodiment of a dynamic wizard data integration and retrieval system;

FIGS. 7A-7E are snapshots illustrating an example embodiment of an extract, transform, load (ETL) data service scenario;

FIGS. 8A-8G are snapshots illustrating an example embodiment of a travel booking scenario; and

FIG. 9 is a block diagram of an example computer system on which methodologies described herein may be executed

### DETAILED DESCRIPTION

Example methods and systems for a dynamic wizard are described. In the following description, for purposes of explanation, numerous specific details are set forth in order to provide a thorough understanding of example embodiments. It will be evident, however, to one skilled in the art that the present embodiments may be practiced without these specific details.

In some embodiments of a dynamic wizard, a predefined guided procedure framework can be presented to an end user. The predefined guided procedure framework can comprise at least one step. The predefined guided procedure framework can be modified in response to prompting from the end user.

In some embodiments, modifying the predefined guided procedure framework comprises creating a user-defined step and inserting the user-defined step into the predefined guided procedure framework. In some embodiments, the predefined guided procedure framework comprises a composite object having multiple attributes, with each attribute being defined by a step in the predefined guided procedure framework. In some embodiments, each attribute comprises at least one parameter. In some embodiments, modifying the predefined guided procedure framework comprises creating a composite object having multiple attributes. Each attribute can be defined by a step in the predefined guided procedure framework. In some embodiments, a modified guided procedure framework is presented to the end user, with the modified guided procedure framework being formed by the modification of the predefined guided procedure framework. In some embodiments, the predefined guided procedure framework is configured for a scenario from a group of scenarios consisting of: an expense report, travel booking, purchase requisition, a purchase order, sourcing documents, logistics, a bill of materials, and an extract, transform, load (ETL) data service. However, it is contemplated that the dynamic wizard of the present disclosure can be domain independent, and thus benefits any guided process where some ad hoc user intervention is desired.

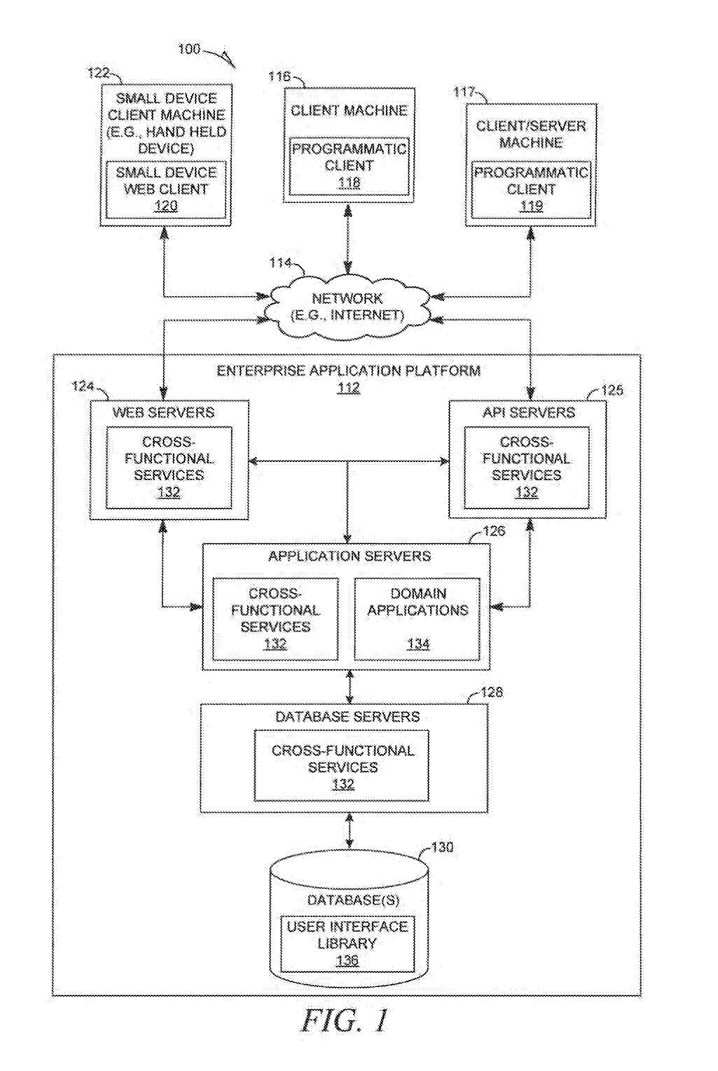

FIG. 1 is a network diagram illustrating a client-server system, within which an example embodiment can be deployed. A platform (e.g., machines and software), in the example form of an enterprise application platform 112, provides server-side functionality via a network 114 (e.g., the Internet) to one or more clients. FIG. 1 illustrates, for example, a client machine 116 with programmatic client 118 (e.g., a browser, such as the INTERNET EXPLORER browser developed by Microsoft Corporation of Redmond, Wash. State), a small device client machine 122 with a small device web client 120 (e.g., a browser without a script engine), and a client/server machine 117 with a programmatic client 119.

Turning specifically to the example enterprise application platform 112, web servers 124 and Application Program Interface (API) servers 125 may be couple to, and provide web and programmatic interfaces to, application servers 126. The application servers 126 may be, in turn, coupled to one or more database servers 128 that facilitate access to one or more databases 130. The web servers 124, Application Program Interface (API) servers 125, application servers 126, and database servers 128 may host cross-functional services 132. The application servers 126 further may host domain applications 134.

The cross-functional services 132 provide services to users and processes that utilize the information enterprise application platform 112. For instance, the cross-functional services 132 may provide portal services (e.g., web services), database services and connectivity to the domain applications 134 for users that operate the client machine 116, the client/server machine 117 and the small device client machine 122. In addition, the cross-functional services 132 may provide an environment for delivering enhancements to existing applications and for integrating third-party and legacy applications with existing cross-functional services 132 and domain applications 134. Further, while the system 100 shown in FIG. 1 employs a client-server architecture, the embodiments of the present invention are of course not limited to such an architecture, and could equally well find application in a distributed, or peer-to-peer, architecture system.

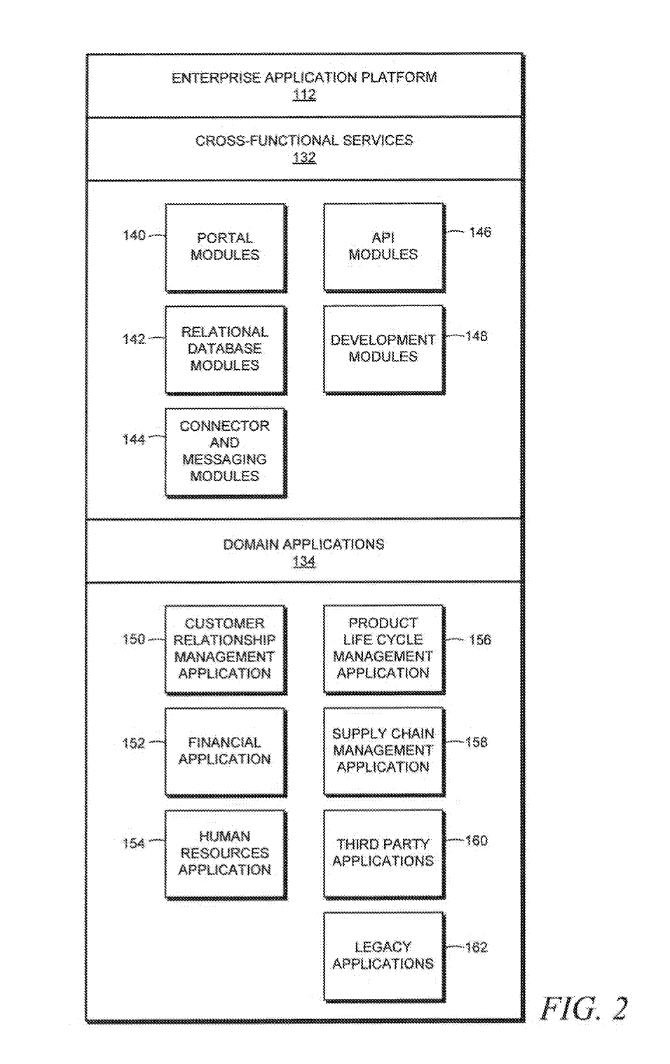

FIG. 2 is a block diagram illustrating example enterprise applications and services deployed on the enterprise application platform 112, according to an example embodiment. The enterprise application platform 112 includes cross-functional services 132 and domain applications 134. The cross-functional services 132 may include portal modules 140, relational database modules 142, connector and messaging modules 144, Application Program Interface (API) modules 146, and development modules 148.

The portal modules 140 may enable a single point of access to other cross-functional services 132 and domain applications 134 for the client machine 116, the small device client machine 122 and the client/server machine 117. The portal modules 140 may be utilized to process, author and maintain web pages that present content (e.g., user interface elements and navigational controls) to the user. In addition, the portal modules 140 may enable user roles, a construct that associates a role with a specialized environment that is utilized by a user to execute tasks, utilize services and exchange information with other users and within a defined scope. For example, the role may determine the content that is available to the user and the activities that the user may perform. The portal modules 140 include a generation module, a communication module, a receiving module and a regenerating module. In addition the portal modules 140 may comply with web services standards and/or utilize a variety of Internet technologies including Java, J2EE, SAP's Advanced Business Application Programming Language (ABAP) and Web Dynpro, XML, JCA, JAAS, X.509, LDAP, WSDL, WSRR, SOAP, UDDI and Microsoft .NET.

The relational database modules 142 may provide support services for access to the database 130, which includes a user interface library 136. The relational database modules 142 may provide support for object relational mapping, database independence and distributed computing. The relational database modules 142 may be utilized to add, delete, update and manage database elements. In addition, the relational database modules 142 may comply with database standards and/or utilize a variety of database technologies including SQL, SQLDBC, Oracle, MySQL, Unicode, and JDBC. In addition or as an alternative to working with a relational database management system, the dynamic wizard of the present disclosure can work with any other data storage system or data management system as well (e.g., in-memory, multidimensional cubes, etc.).

The connector and messaging modules 144 may enable communication across different types of messaging systems that are utilized by the cross-functional services 132 and the domain applications 134 by providing a common messaging application processing interface. The connector and messaging modules 144 may enable asynchronous communication on the enterprise application platform 112.

The Application Program Interface (API) modules 146 may enable the development of service-based applications by exposing an interface to existing and new applications as services. Repositories may be included in the platform as a central place to find available services when building applications.

The development modules 148 may provide a development environment for the addition, integration, updating and extension of software components on the enterprise application platform 112 without impacting existing cross-functional services 132 and domain applications 134.

Turning to the domain applications 134, the customer relationship management application 150 may enable access to, and may facilitate collecting and storing of, relevant personalized information from multiple data sources and business processes. Enterprise personnel that are tasked with developing a buyer into a long-term customer may utilize the customer relationship management applications 150 to provide assistance to the buyer throughout a customer engagement cycle.

Enterprise personnel may utilize the financial applications 152 and business processes to track and control financial transactions within the enterprise application platform 112. The financial applications 152 may facilitate the execution of operational, analytical and collaborative tasks that are associated with financial management. Specifically, the financial applications 152 may enable the performance of tasks related to financial accountability, planning, forecasting, and managing the cost of finance.

The human resources applications 154 may be utilized by enterprise personal and business processes to manage, deploy, and track enterprise personnel. Specifically, the human resource applications 154 may enable the analysis of human resource issues and facilitate human resource decisions based on real time information.

The product life cycle management applications 156 may enable the management of a product throughout the life cycle of the product. For example, the product life cycle management applications 156 may enable collaborative engineering, custom product development, project management, asset management and quality management among business partners.

The supply chain management applications 158 may enable monitoring of performances that are observed in supply chains. The supply chain management applications 158 may facilitate adherence to production plans and on-time delivery of products and services.

The third-party applications 160, as well as legacy applications 162, may be integrated with domain applications 134 and utilize cross-functional services 132 on the enterprise application platform 112.

In some embodiments, a dynamic wizard is a software environment that provides guidance for end users to perform an operational step or a sequence of operational steps in order to reach their goals, while at the same time allowing end users to describe operational steps of the guided activity. It enables an end user to efficiently create or edit a composite object. A composite object is an object that has multiple parts. The dynamic wizard utilizes a predefined guided procedure, where each step of the procedure defines an attribute of the composite object. The end user can change or add attributes to the guided procedure. The user may add an attribute by adding or inserting a step into the guided flow.

The dynamic wizard can have a very broad application for creation and editing of any composite objects. Scenarios may include, but are not limited to, an expense report, travel booking, purchase requisition, a purchase order, sourcing documents, logistics, a bill of materials, and ETL data services on demand. It is contemplated that the dynamic wizard can be configured for other scenarios as well.

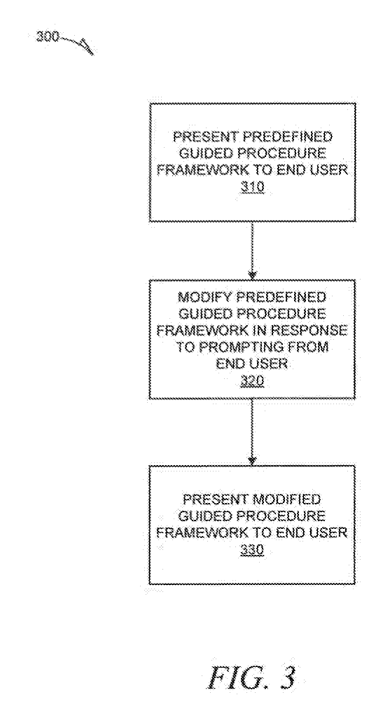

FIG. 3 is a flowchart illustrating an example embodiment of a dynamic wizard method 300. At operation 310, a predefined guided procedure framework comprises at least one step. At operation 320, the predefined guided procedure framework is modified in response to prompting from the end user. At operation 330, the modified guided procedure framework formed at operation 320 is presented to the end user.

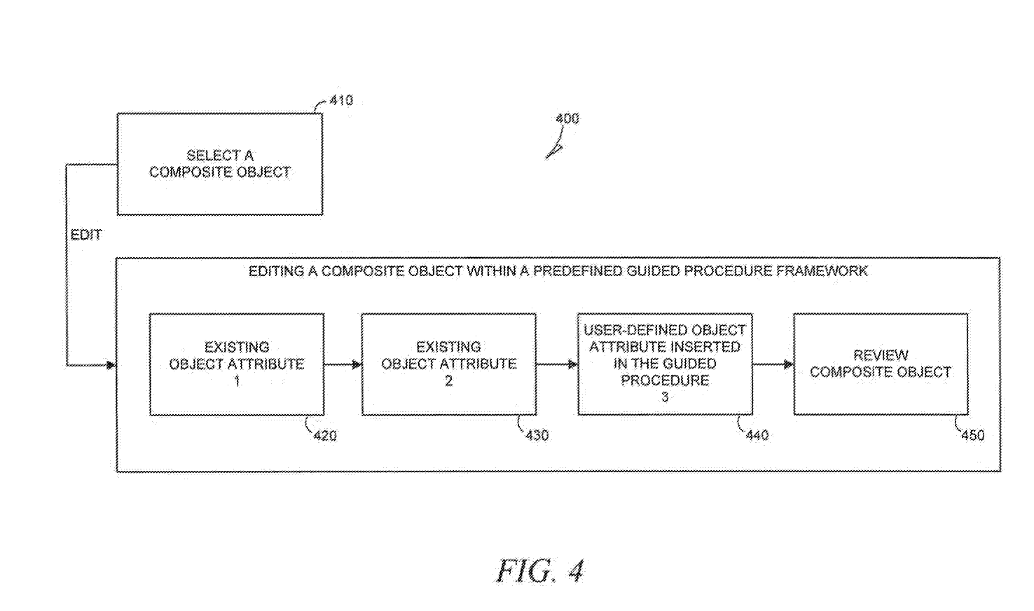

FIG. 4 is a flow diagram illustrating an example embodiment of a dynamic wizard task flow 400 for editing a composite object. For editing a composite object, such as a travel itinerary or data flow, the end user selects a composite object, at 410. The end user then edits the composite object's attributes using the dynamic wizard. For example, an attribute can be created and inserted into the composite object by the end user. This attribute becomes a step in the predefined guided procedure framework along with the other existing steps. In the example embodiment of FIG. 4, the first step 420 within the predefined guided procedure framework is a predefined existing object attribute. The second step 430 is another predefined existing object attribute. The next step 440 is the user-defined object attribute that was created and inserted into the guided procedure by the end user. At the final step 450 within the guided procedure framework, the end user can review the composite object.

One composite object can contain multiple attributes. In one example, the logistical legs of a journey are attributes of an itinerary composite object. For example, a user may need to travel from San Francisco to New York. The user also needs to stop in Los Angeles and Boston. The dynamic wizard can help the user create all of the travels depending on what business requirements he needs. Each location is an attribute. In an example dealing with a bill of materials scenario, the attributes can be the individual items to be listed in the bill of materials. In an ETL scenario, the attributes can be transactions or transforms.

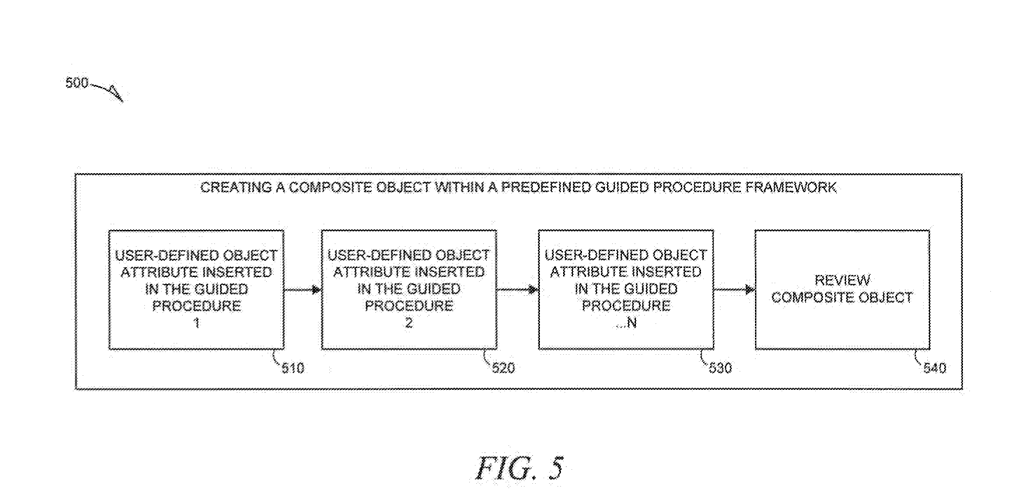

FIG. 5 is a flow diagram illustrating an example embodiment of a dynamic wizard task flow 500 for creating a composite object. In some embodiments, when creating a composite object, the end user is presented with a framework having very few steps. The end user can fill the framework based on his needs by defining object attributes and inserting them into the guided procedure. The end user can be presented with an initial step and a final step, and can then fill everything in between. In the example embodiment of FIG. 5, the first step 510 within the predefined guided procedure framework is a user-defined object attribute that has been inserted into the guided procedure at the prompting of the end user. The second step 520 within the predefined guided procedure framework is another user-defined object attribute that has been inserted into the guided procedure at the prompting of the end user. The Nth step 530 within the predefined guided procedure framework is yet another user-defined object attribute that as been inserted into the guided procedure at the prompting of the end user. At the final step 540 within the guided procedure framework, the end user can review the composite object.

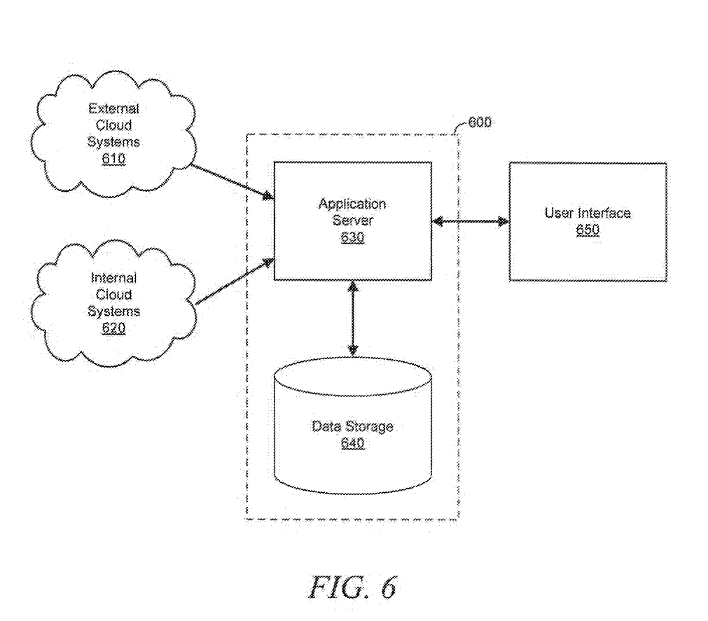

FIG. 6 is a block diagram illustrating an example embodiment of a dynamic wizard data integration and retrieval system 600, showing how data can be requested and brought to end users. The data may live on external cloud systems 610 and internal cloud systems 620. An application server 630 can request and bring this data into data storage 640. From this data storage 640, the data can be exposed to an end user through a user interface 650. The user interface 650 can include, but is not limited to, a web browser and an application programming interface (API) communicating with the application server 630. The dynamic wizard can be implemented on the application server 630.

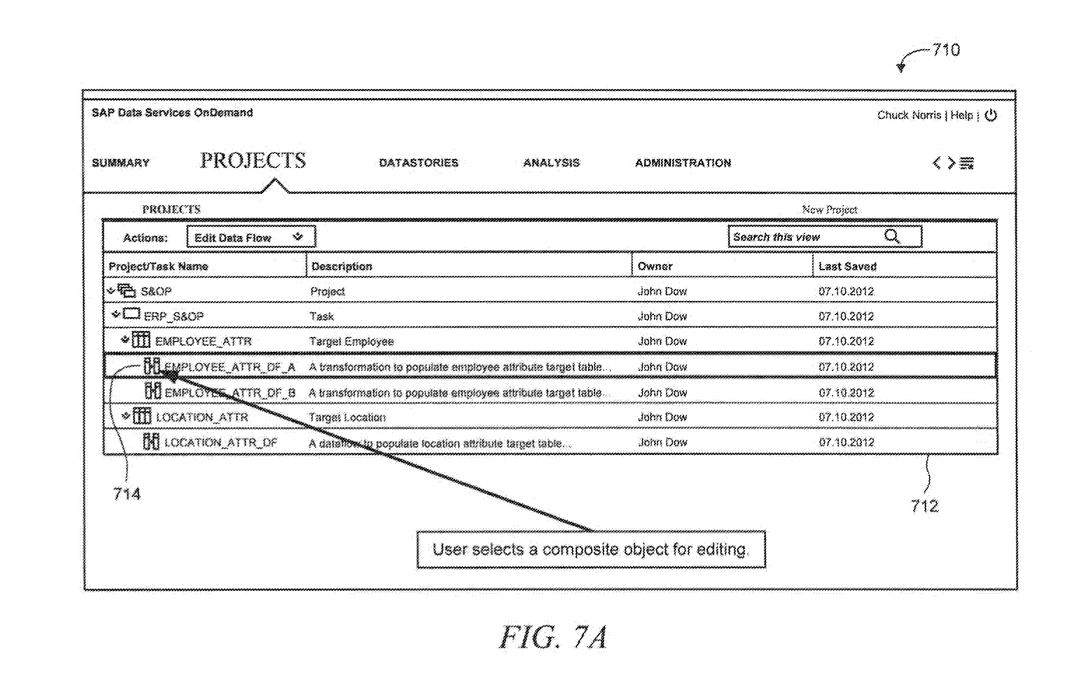

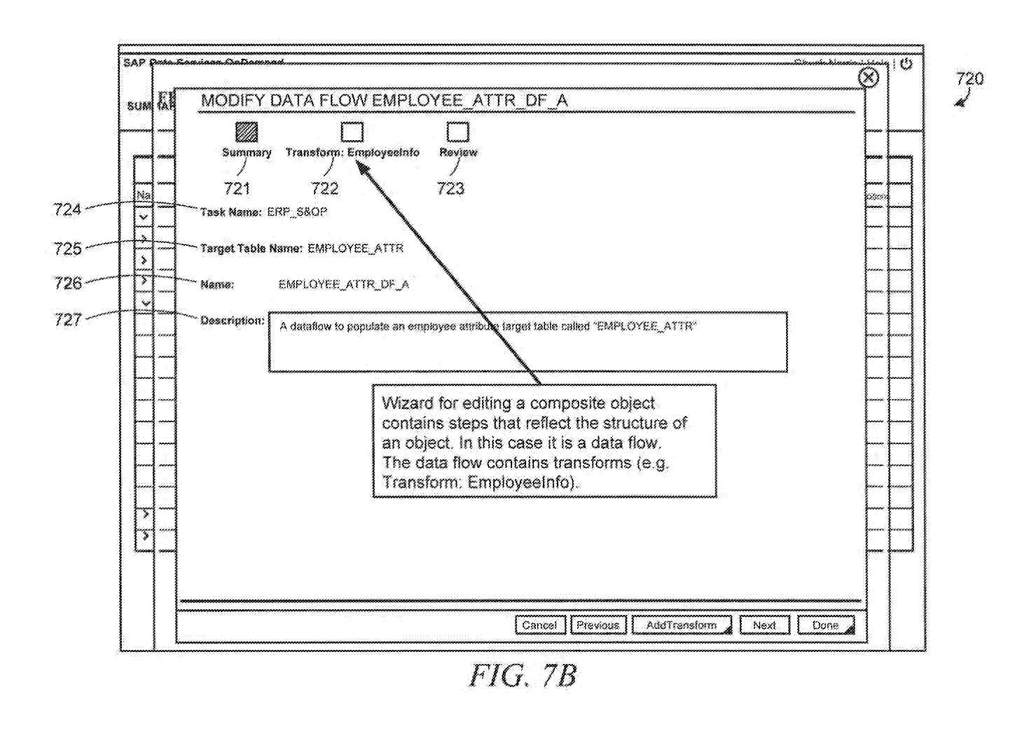

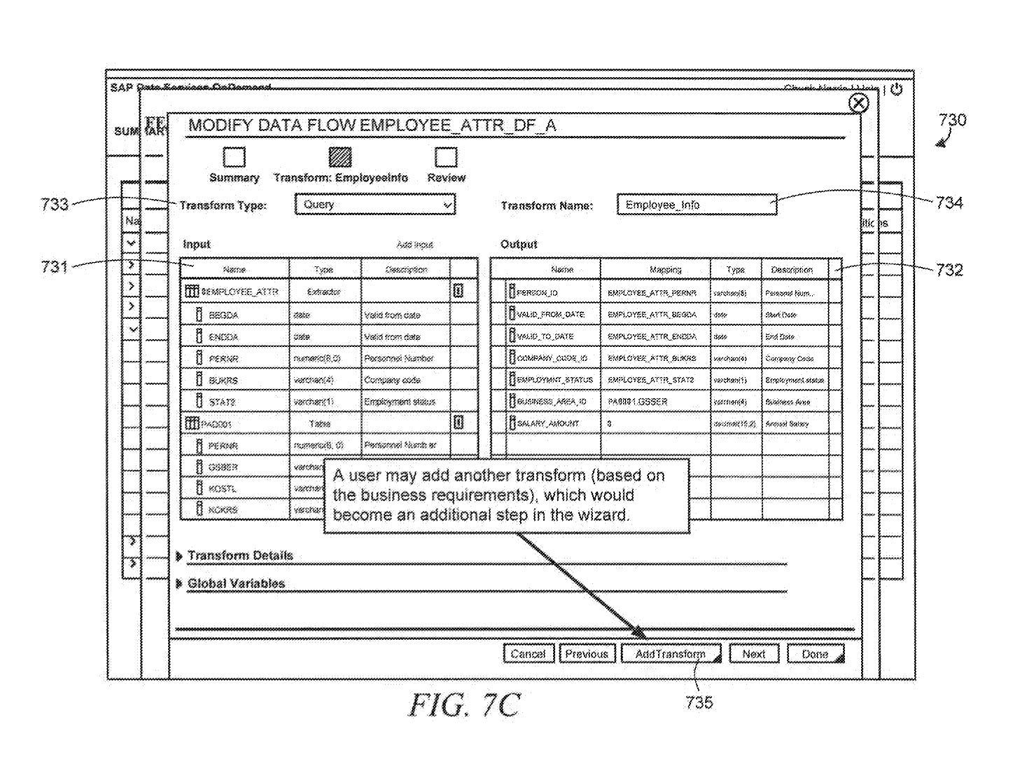

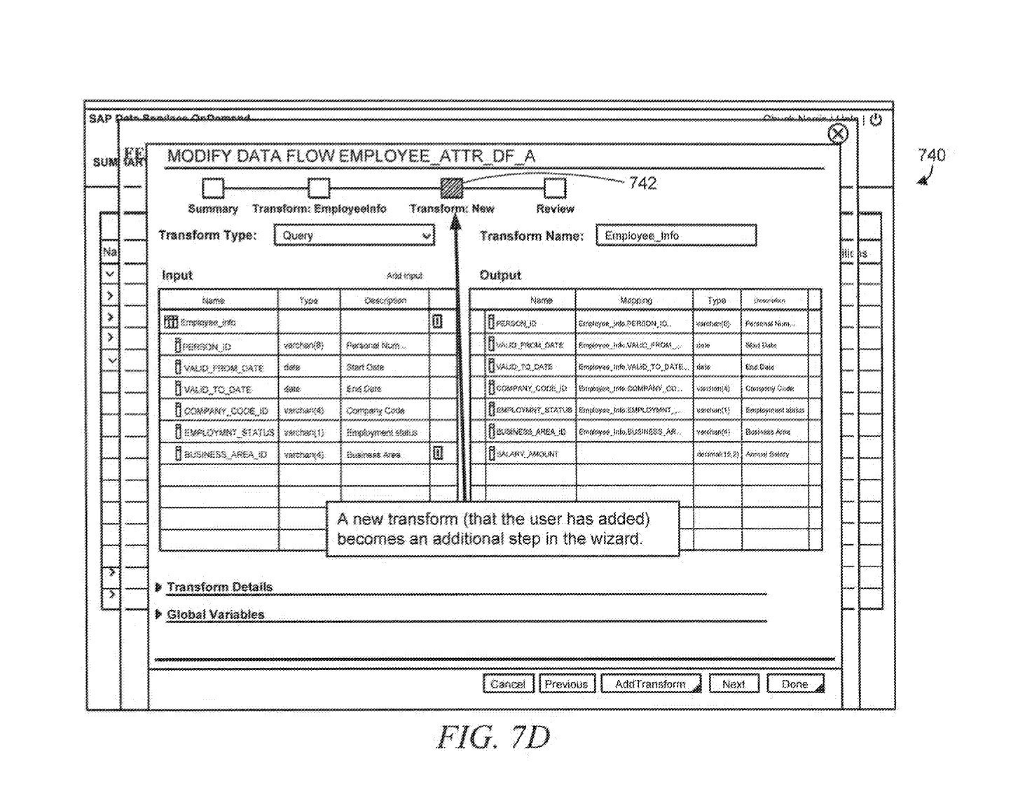

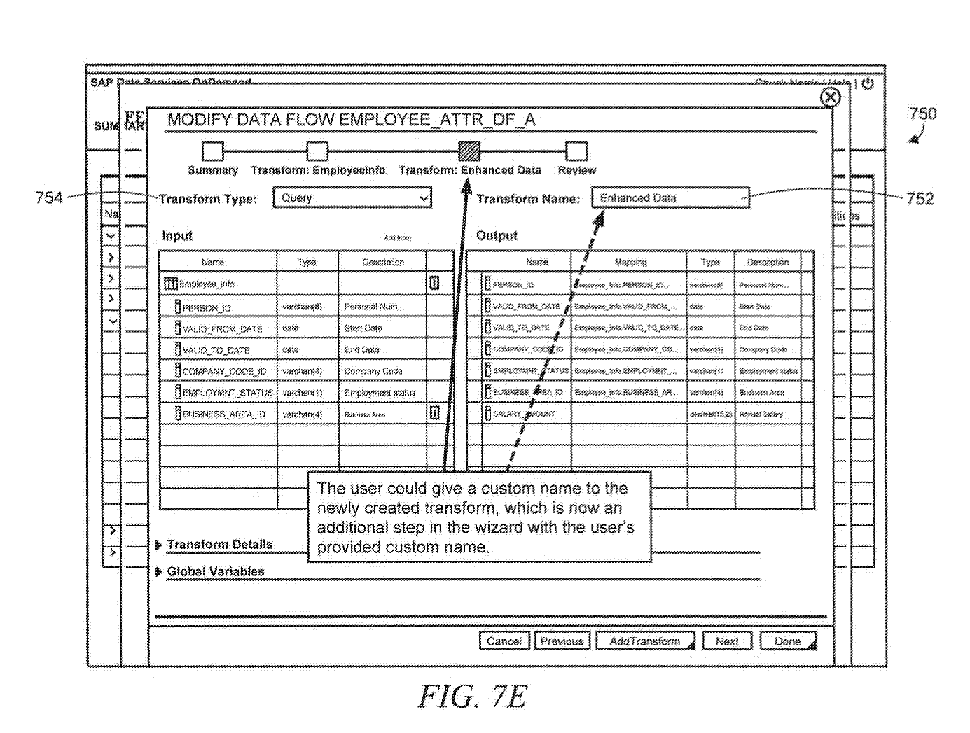

FIGS. 7A-7E are snapshots illustrating an example embodiment of an extract, transform, load (ETL) data service scenario. In FIG. 71, snapshot 710 shows a table 712 that contains composite objects 714. The user can select a composite object 714 for editing, such as “EMPLOYEE_ATTR_DF_A,” which is a data flow.

After selection of the composite object 714 for editing, a wizard for editing the composite object 714 can be opened, as shown in snapshot 720 of FIG. 7B. The wizard can contain a number of steps that reflect the structure of the composite object 714. In this example, the composite object 714 is a data flow containing transforms (e.g., “Transform: EmployeeInfo”) and three steps: a summary step 721 (“Summary”), a transform step 722 (“Transform: EmployeeInfo”), and a review step 723 (“Review”). The snapshot 720 shows the first step in the wizard, which is a summary of the composite object 714. The summary can show details about the composite object 714. These details can include, but are not limited to, a task name 724, a target table name 725, a name 726 of the composite object 714, and a description 727 of the composite object 714.

As seen in snapshot 730 of FIG. 7C, the user can review the transform. Snapshot 730 shows the mapping of entities from an input table 731 to an output table 732. The user can move data from a source to a target. Between the source and the target, a process can be performed on the data before it is loaded into the target. The process can include, but is not limited to, aggregating data, joining data, and filtering data. These dynamic steps can be defined by the end user. The data transition from input to output may have different routes. Using the dynamic wizard, the end user can be presented with the initial point and the final point, but build anything in between these points. The transform is an attribute of the composite object 714 and can comprise parameters that are particular to the application. Examples of parameters include, but are not limited to, a transform type 733 and a transform name 734. In these examples, you can identify your transform type 733, and the transform type 733 can dictate what you can do with this type of transform. The transform name 734 can be a unique name of the step. The end user can introduce a new step and name this step. This name can then become a step in the wizard. In a shopping scenario, the transform type 733 can be a category. For example, if the end user needs to shop for a book and then for furniture, these steps can fall into different categories, and therefore result in different kinds of input for these steps.

With the dynamic wizard, the end user can be presented with a step. The end user can introduce another step into the wizard by adding another transform or another step to the guided procedure. For the added step, the dynamic wizard takes the output of the previous step as an input for this added step, and the output for the added step can be defined by the transform. This mapping can be done as many times as needed in order to accomplish a business task. The end user is not restricted to only a predefined specific set of steps. The end user can make changes to the set of steps and introduce what he thinks is important.

Referring back to the snapshot 730 of FIG. 7C, the end user can add another transform. The end user can initiate this addition of the transform by clicking an icon, for example, the “Add Transform” icon 735, or by a variety of other means. This additional transform can then become an additional step in the wizard. This additional transform can be based on business requirements. Snapshot 740 of FIG. 7D shows the introduction of an additional transform 742 as an additional step in the guided procedure of the dynamic wizard. As seen in snapshot 750 of FIG. 7E, the end user can give a custom name 752 and type 754 to the newly created transform, which is now an additional step in the guided procedure of the wizard.

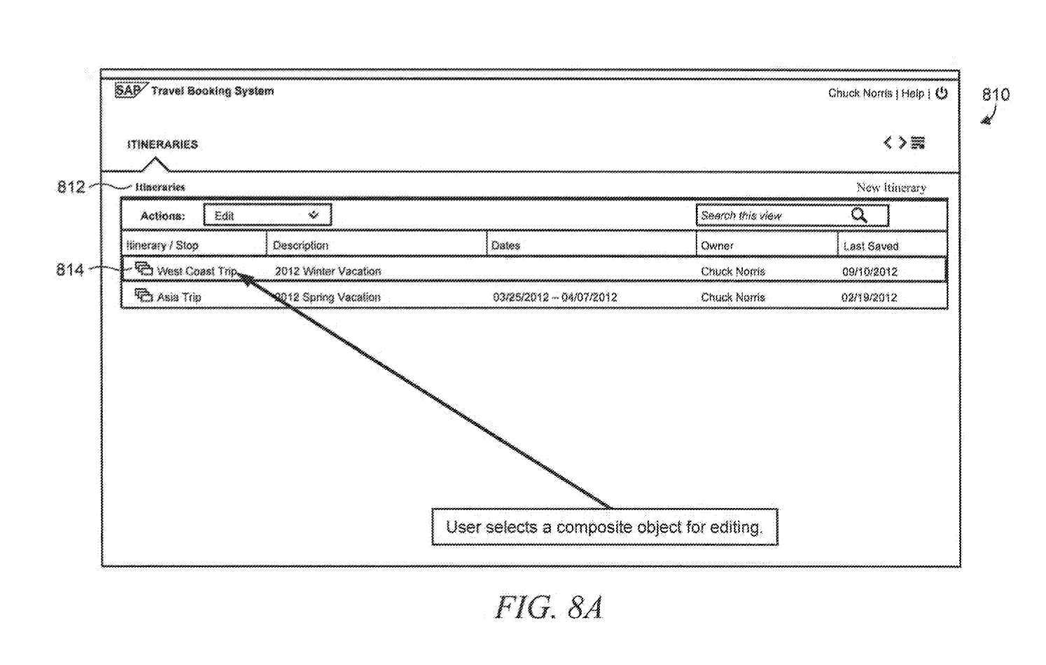

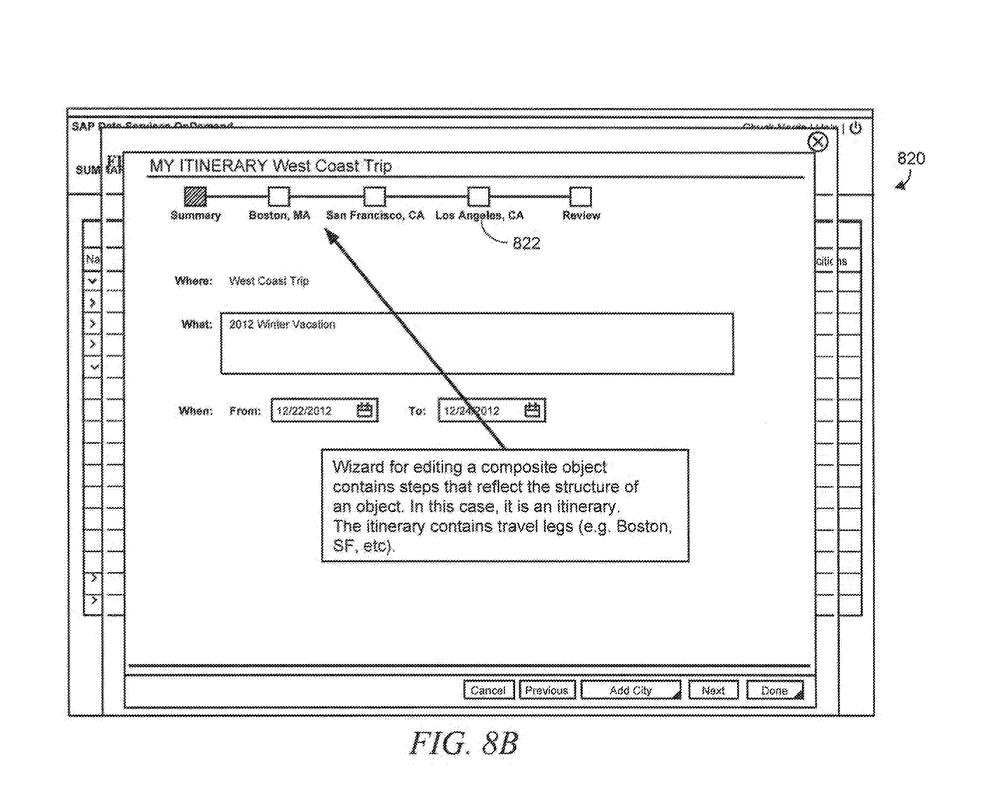

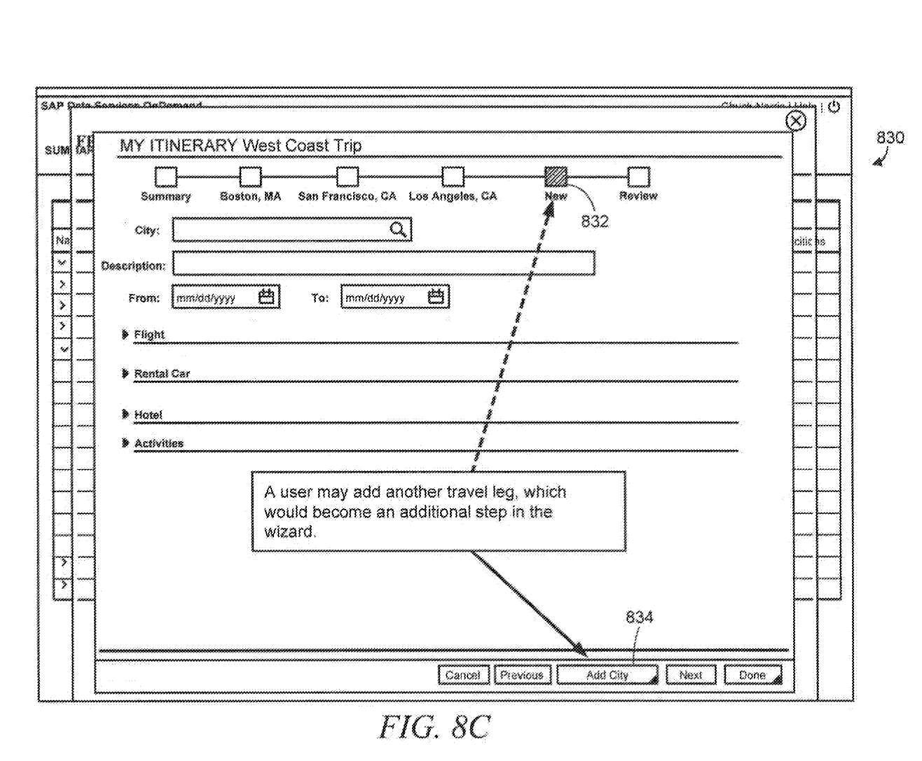

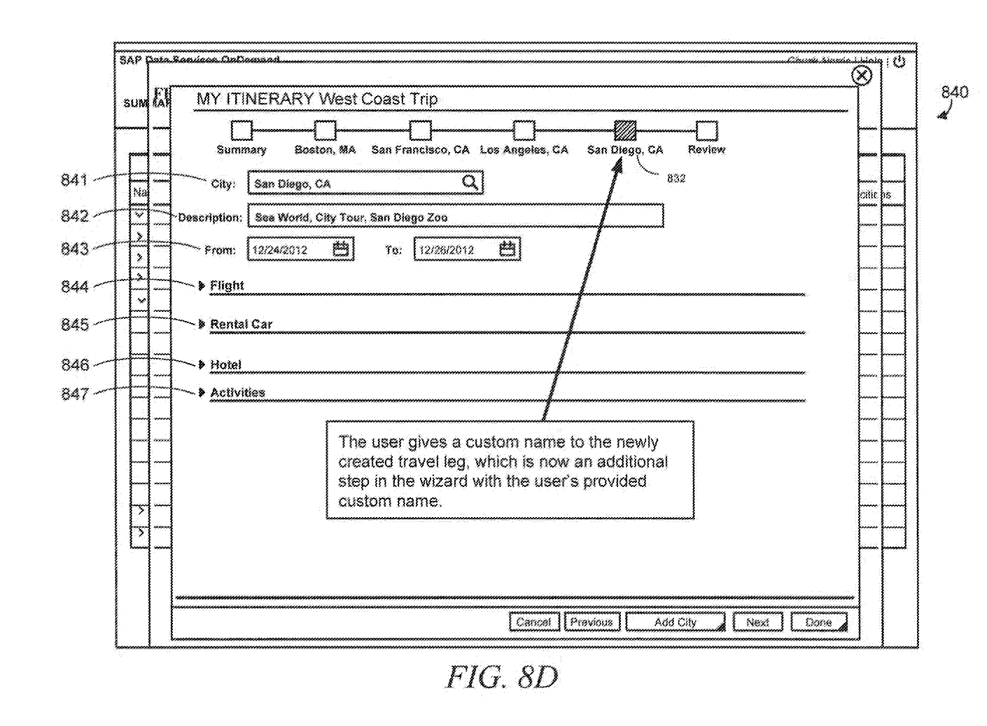

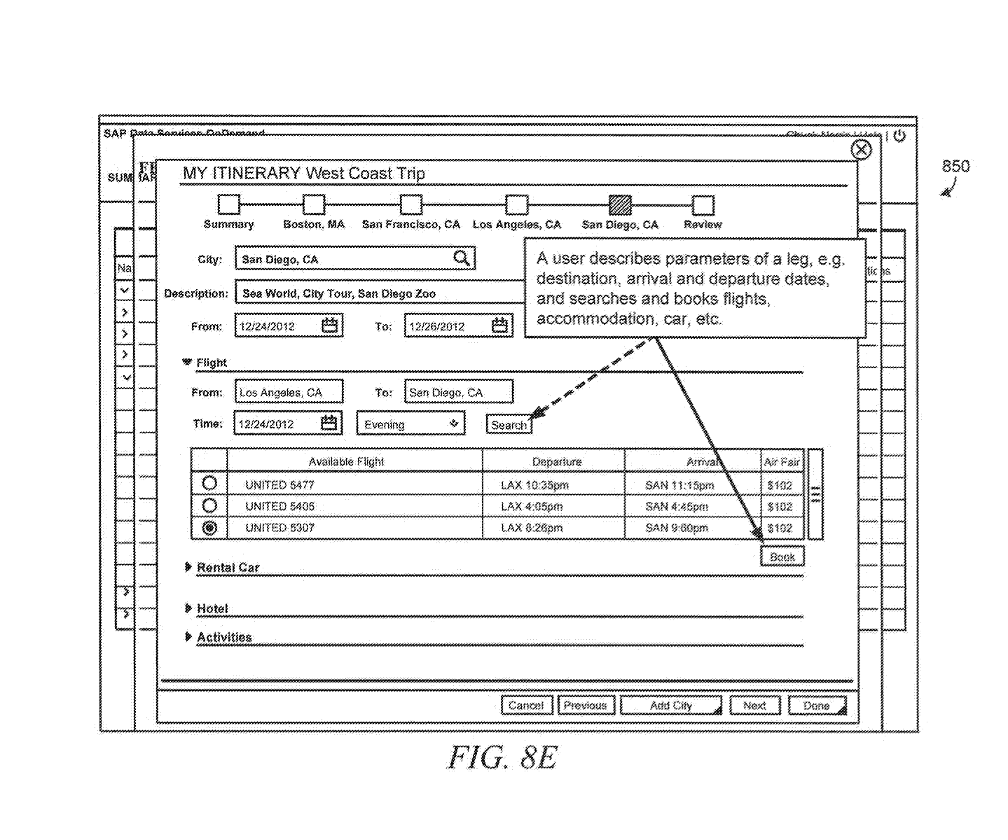

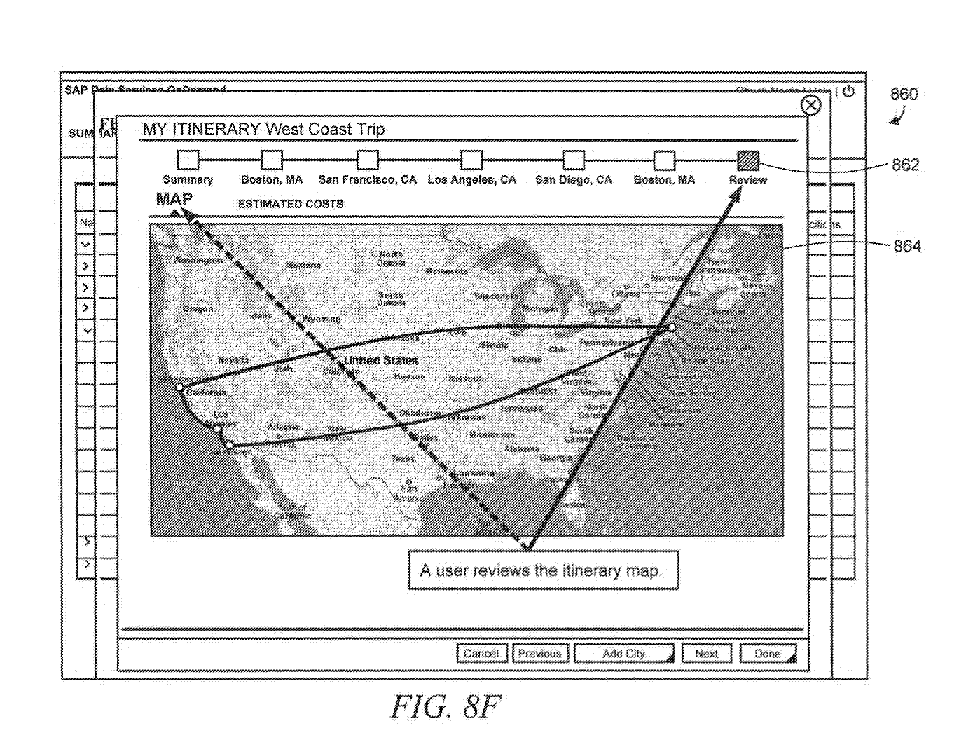

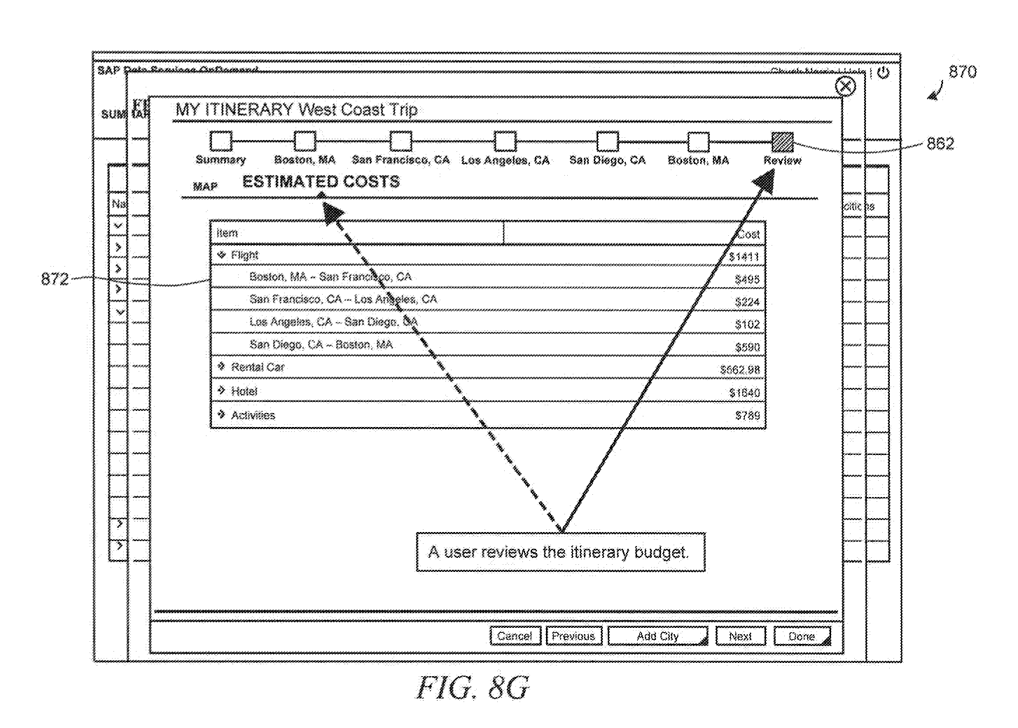

FIGS. 8A-8G are snapshots illustrating an example embodiment of a travel booking scenario. Snapshot 810 of FIG. 8A shows a list 812 of itineraries 814. Each itinerary 814 is a composite object that the user can select for editing.

Snapshot 820 of FIG. 8B shows a dynamic wizard for editing a composite object. The dynamic wizard contains steps that reflect the structure of the selected composite object, which, in this example, is an itinerary labeled “West Coast Trip.” Snapshot 820 shows a summary of the itinerary, which, in this example, is a trip from Boston to San Francisco to Los Angeles. The user can then review this itinerary at the end.

Snapshot 830 of FIG. 8C shows that an end user can introduce a new step 832 into the guided procedure. The end user can introduce this new step 832 by clicking an icon, for example, the “Add City” icon 834, or by a variety of other means. In this scenario, the new step is another travel leg. For example, let's say that after Los Angeles, the end user would like to do something else. The end user can specify what in particular he wants to do.

Snapshot 840 of FIG. 8D shows the user providing details for this new step. These details are the parameters of the step, and each step is a leg of the itinerary. The end user can also specify parameters including, but not limited to, a destination 841, a description of the trip to that destination 842, the dates of that trip 843, flight information 844, rental car information 845, hotel information 846, and activities 847 in which he would like to partake, as well as many other types of attribute parameters. In this example, the end user has specified that he would like to go to San Diego after Los Angeles, and that he would to see Sea World, go on a city tour, and see the San Diego Zoo. In some embodiments, the information comes from heterogeneous sources. For example, flight information can be consolidated information from different flight providers, hotel information can be obtained from a different cloud, and car rental information can be obtained from a different cloud as well. Each component can be a consolidation from other data sources.

Snapshot 850 of FIG. 8E shows that an end user can describe parameters of a leg of the itinerary. For example, the end user can describe the destination, the arrival date, and the departure date. The end user can also search for and book flights, accommodations, a rental car, etc.

Snapshot 860 of FIG. 8F shows the final review step 862 of the guided procedure. Here, an end user is able to review a map 864 of his itinerary, from Boston to San Francisco to Los Angeles to San Diego to Boston.

Snapshot 870 of FIG. 8G shows another aspect of the final review step 862. Here, an end user can review the itinerary budget and look at cost estimates for his trip.

In some embodiments, the dynamic wizard provides a guided activity having predefined steps, for example, an initial step and a final step. The end user is provided a framework that allows him to understand what the user model is and enables him to add steps to the guided activity. In some embodiments, the end user is provided the framework at the beginning, which can include a summary step and a review step. The end user can amend this framework by adding steps, editing parameters of steps, and rearranging steps. It is contemplated that the end user can amend the framework in other ways as well.

For each business demand, you may already have a predefined framework that is already tied to a workflow, which means that each time you go through step by step, it generates an event and triggers some process or processes. For example, the end user can select the location where he would like to go, and therefore, when he is going to book flights, the system already knows which region and what type of flights to provide him. Similarly, when an end user is specifying a new transform, the dynamic wizard knows what to insert for input and for output.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing”environment or as a “software as a service” (SaaS). For example, at least some of the operations may be performed by a group of computers (as examples of machines including processors), these operations being accessible via a network (e.g., the network 114 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporary configured hardware (e.g., any combination of software and a programmable processor), or a combination of permanently and temporarily configured hardware may be a design choice. Below are set out hardware (e.g., machine) and software architectures that may be deployed, in various example embodiments.

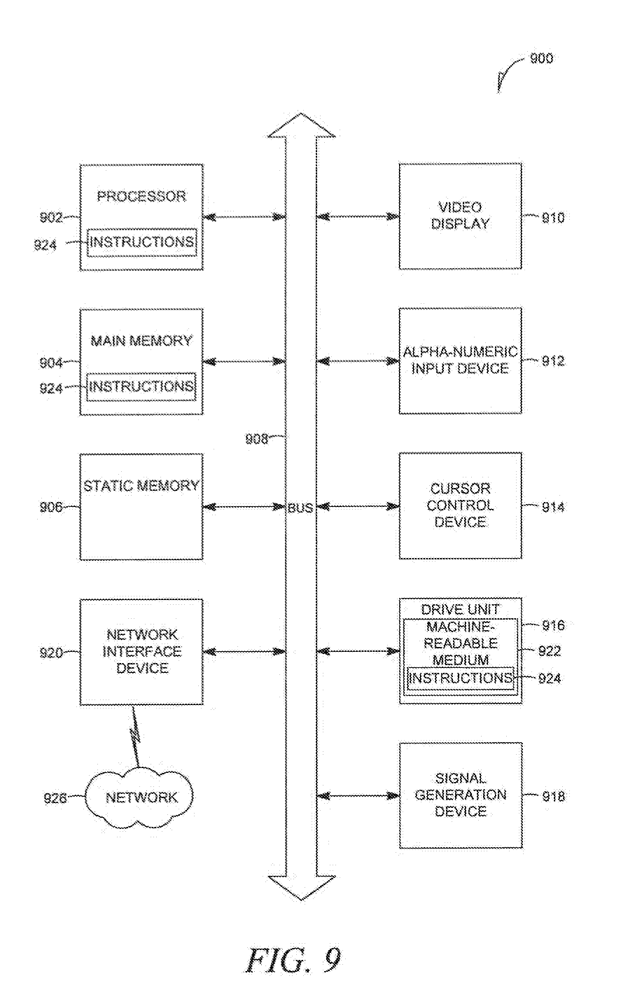

FIG. 9 is a block diagram of a machine in the example form of a computer system 900 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation (or cursor control) device 914 (e.g., a mouse), a disk drive unit 916, a signal generation device 918 (e.g., a speaker) and a network interface device 920.

The disk drive unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media. The instructions 924 may also reside, completely or at least partially, within the static memory.

While the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding or carrying instructions for execution by the medium and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including any by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a LAN, a WAN, the Internet, mobile telephone networks, plain old telephone service (POTS) networks, and wireless data networks (e.g., WiFi and WiMAX networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
presenting a predefined guided procedure framework to an end user, the predefined guided procedure framework comprising at least one step; and
modifying the predefined guided procedure framework in response to prompting from the end user.

2. The method of claim 1, wherein modifying the predefined guided procedure framework comprises creating a user-defined step and inserting the user-defined step into the predefined guided procedure framework.

3. The method of claim 1, wherein the predefined guided procedure framework comprises a composite object having multiple attributes, each attribute being defined by a step in the predefined guided procedure framework.

4. The method of claim 3, wherein each attribute comprises at least one parameter.

5. The method of claim 1, wherein modifying the predefined guided procedure framework comprises creating a composite object having multiple attributes, each attribute being defined by a step in the predefined guided procedure framework.

6. The method of claim 1, further comprising presenting a modified guided procedure framework to the end user, wherein the modified guided procedure framework is formed by the modifying of the predefined guided procedure framework.

7. The method of claim 1, wherein the predefined guided procedure framework is configured for a scenario from a group of scenarios consisting of: an expense report, travel booking, purchase requisition, a purchase order, sourcing documents, logistics, a bill of materials, and an extract, transform, load (ETL) data service.

8. A system comprising:
a machine having at least one processor; and
a dynamic wizard operable on the machine and configured to:
present a predefined guided procedure framework to an end user, the predefined guided procedure framework comprising at least one step; and
modify the predefined guided procedure framework in response to prompting from the end user.

9. The system of claim 8, wherein the dynamic wizard is configured to modify the predefined guided procedure framework by creating a user-defined step and inserting the user-defined step into the predefined guided procedure framework.

10. The system of claim 8, wherein the predefined guided procedure framework comprises a composite object having multiple attributes, each attribute being defined by a step in the predefined guided procedure framework.

11. The system of claim 10, wherein each attribute comprises at least one parameter.

12. The system of claim 8, wherein the dynamic wizard is configured to modify the predefined guided procedure framework by creating a composite object having multiple attributes, each attribute being defined by a step in the predefined guided procedure framework.

13. The system of claim 8, wherein the dynamic wizard is further configured to present a modified guided procedure framework to the end user, wherein the modified guided procedure framework is formed by the modification of the predefined guided procedure framework.

14. The system of claim 8, wherein the predefined guided procedure framework is configured for a scenario from a group of scenarios consisting of: an expense report, travel booking, purchase requisition, a purchase order, sourcing documents, logistics, a bill of materials, and an extract, transform, load (ETL) data service.

15. A non-transitory machine-readable storage device, tangibly embodying a set of instructions that, when executed by at least one processor, causes the at least one processor to perform operations comprising:
presenting a predefined guided procedure framework to an end user, the predefined guided procedure framework comprising at least one step; and
modifying the predefined guided procedure framework in response to prompting from the end user.

16. The device of claim 15, wherein modifying the predefined guided procedure framework comprises creating a user-defined step and inserting the user-defined step into the predefined guided procedure framework.

17. The device of claim 15, wherein the predefined guided procedure framework comprises a composite object having multiple attributes, each attribute being defined by a step in the predefined guided procedure framework.

18. The device of claim 17, wherein each attribute comprises at least one parameter.

19. The device of claim 15, wherein modifying the predefined guided procedure framework comprises creating a composite object having multiple attributes, each attribute being defined by a step in the predefined guided procedure framework.

20. The device of claim 15, wherein the operations further comprise presenting a modified guided procedure framework to the end user, wherein the modified guided procedure framework is formed by the modifying of the predefined guided procedure framework.
